(19) United States
(12) Patent Application Publication
(10) Pub. No.: US 2007/0195335 A1
(43) Pub. Date: Aug. 23, 2007

(54) Image forming apparatus

(75) Inventor: Toshihide Tanaka, Shizuoka-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/238,875

(22) Filed: Sep. 28, 2005

(51) Int. Cl. G06F 3/12

(52) U.S. Cl. 358/1.1; 358/1.2

(57) ABSTRACT

An image forming apparatus of the invention is capable of performing stapling or punching in any of a corner, a long side, and a short side of printed recording sheets. Upon receipt of a print job on the recording sheets, when stapling or punching is set in the print job, whether the recording sheets are set in a direction in which stapling or punching is enabled is judged. When the recording sheets are not set in the direction, the print job is saved in an image storage portion together with a save serial number. For the saved print jobs, whether a printing execution suspending condition has been removed is judged. For a print job for which the condition has been removed, printing on the recording sheets is executed, and the save serial numbers appended to the print jobs saved in the image storage portion are moved up.

### BACKGROUND OF THE INVENTION

1. Field of the Invention

The present invention relates to an image forming apparatus that executes printing on recording sheets according to a print job and is available with a post-processing device that performs stapling or punching on printed recording sheets.

2. Description of the Related Art

An image forming apparatus that prints out image information inputted in a specific manner on recording sheets by a print job, such as a copier, a printer, or multi-function peripherals (MFP) furnished with functions of these machines, has been used extensively. The image forming apparatus includes a type available with a post-processing device that performs stapling or punching processing on printed recording sheets. When stapling or punching processing is performed, the stapling or punching processing is performed in a portion the user specified in the print job. However, even when the user wishes stapling processing or punching processing to be performed, there may be a case where the stapling or punching processing cannot be performed on printed recording sheets.

The post-processing, such as stapling processing or punching processing, cannot be performed on printed recording sheets, for example, (1) when no staples are loaded, (2) when a large quantity of paper dust is left in a paper discharge tray, and (3) when punching wastage is accumulated to the full. In this case, when printing is executed without performing post-processing, useless print outputs are produced. Japanese Official Gazette, JP-A-11-353142, discloses one example of a technique for avoiding useless print outputs. To be more specific, when the current state applies to any one of the three conditions specified above, stapling processing or punching processing is not performed immediately. Instead, the operation is switched to the processing of accumulating input image data into image storage means without canceling a stapling command or a punching command.

However, in a case where stapling or punching processing is not performed for a print job with a stapling command or a punching command for a reason other than the conditions specified above, printed recording sheets are outputted without being stapled or punched, which results in wastage of recording sheets, toner, etc.

### BRIEF DESCRIPTION OF THE DRAWINGS

FIG. 1 is a schematic view used to describe that stapling or punching processing can be performed at the upper left corner of a pile of recording sheets printed in the portrait direction;

FIG. 2 is a schematic view used to describe that stapling or punching processing can be performed at the upper left corner of a pile of recording sheets printed in the landscape direction;

FIG. 3 is a schematic view used to describe that when stapling or punching processing is specified in the long side portion of a pile of recording sheets printed in the portrait direction, stapling or punching is performed on recording sheets set in the portrait orientation and stapling or punching is not performed on recording sheets set in the landscape orientation;

FIG. 4 is a schematic view used to describe that when stapling or punching processing is specified in the long side portion of a pile of recording sheets printed in the landscape direction, stapling or punching is performed on recording sheets set in the portrait orientation and stapling or punching is not performed on recording sheets set in the landscape orientation;

FIG. 5 is a schematic view used to describe that when stapling or punching processing is specified in the short side portion of a pile of recording sheets printed in the portrait direction, stapling or punching is performed on recording sheets set in the landscape orientation and stapling or punching is not performed on recording sheets set in the portrait orientation;

FIG. 6 is a schematic view used to describe that when stapling or punching processing is specified in the short side portion of a pile of recording sheets printed in the landscape direction, stapling or punching is performed on recording sheets set in the landscape orientation and stapling or punching is not performed on recording sheets set in the portrait orientation;

FIG. 7 is a schematic view used to describe that when stapling or punching processing is specified at the upper right corner of a pile of recording sheets printed in the portrait direction, stapling or punching is performed on recording sheets set in the landscape orientation and stapling or punching is not performed on recording sheets set in the portrait orientation;

FIG. 8 is a schematic view used to describe that when stapling or punching processing is specified at the upper right corner of a pile of recording sheets printed in the landscape direction, stapling or punching is performed on recording sheets set in the portrait orientation and stapling or punching is not performed on recording sheets set in the landscape orientation;

FIG. 9 is a functional block diagram schematically showing the configuration of an image forming apparatus according to a first embodiment of the invention;

FIG. 10 is a flow chart detailing an overall operation in the first embodiment of the invention; and

FIG. 11 is a flow chart detailing the judgment process for conditions under which stapling is not performed in the first embodiment of the invention.

### DETAILED DESCRIPTION OF THE INVENTION

Throughout this description, the embodiments and examples shown should be considered as exemplars, rather than limitations on the apparatus of the present invention.

Hereinafter, embodiments of the invention will be described in detail using accompanying drawings as examples.

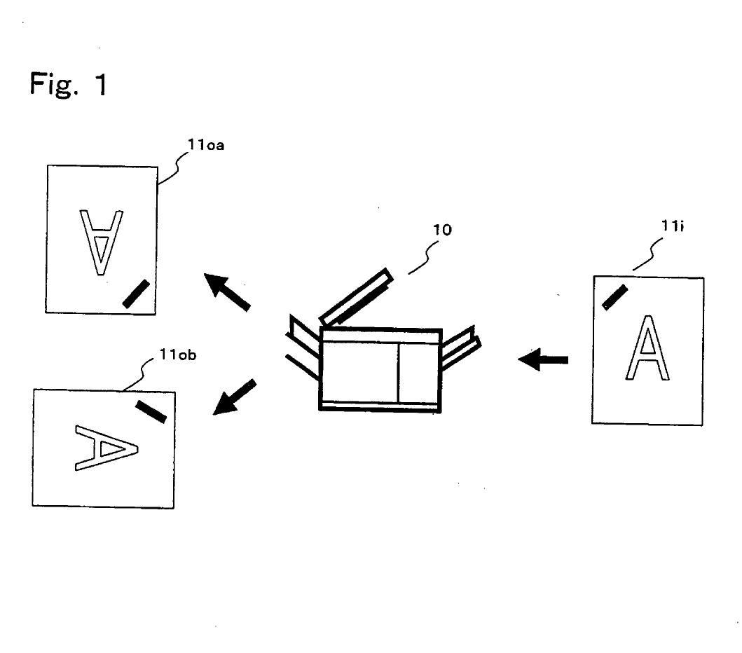

A case where stapling or punching processing is not performed when a document created on a PC or the like is printed out will be described first with reference to FIG. 1 through FIG. 9. Four cases A through D as follows are thought to apply to the case where stapling or punching processing is not performed. When the current state applies to any of these cases, stapling or punching processing cannot be performed in a manner as the user desires.

A: a case where the user wishes rectangular recording sheets to be stapled or punched in the long side portion, but recording sheets of the portrait configuration (an orientation for the long side portion of the recording sheets to be perpendicular to the direction of transportation) are not set in the paper feeding portion of the image forming apparatus.

B: a case where the user wishes rectangular recording sheets to be stapled or punched in the short side portion, but recording sheets of the landscape configuration (an orientation for the short side portion of recording sheets to be perpendicular to the direction of transportation) are not set in the paper feeding portion of the image forming apparatus.

C: a case where the user wishes portrait recording sheets to be stapled at the upper right corner, but recording sheets of the landscape configuration are not set in the paper feeding portion of the image forming apparatus.

D: a case where the user wishes landscape recording sheets to be stapled at the upper right corner, but recording sheets of the portrait configuration are not set in the paper feeding portion of the image forming apparatus.

Hereinafter, the relation of stapling processing and recording sheets set in the paper feeding portion will be described concretely with reference to FIG. 1 through FIG. 8. In each of FIG. 1 through FIG. 8, the manner of the print out (the print out is equivalent to an input image) and the stapling processing the user desires is shown on the right of the drawing. Also, in each drawing, the manner of a printed recording sheet that is printed by the image forming apparatus and finally outputted from the post-processing device when recording sheets of the portrait configuration are set in the paper feeding portion of the image forming apparatus is shown on the upper left of the drawing. Further, in each drawing, the manner of a printed recording sheet that is printed by the image forming apparatus and finally outputted from the post-processing device when recording sheets of the landscape configuration are set in the paper feeding portion of the image forming apparatus is shown on the lower left of the drawing. The image forming apparatus and the post-processing device are shown at the center of each drawing.

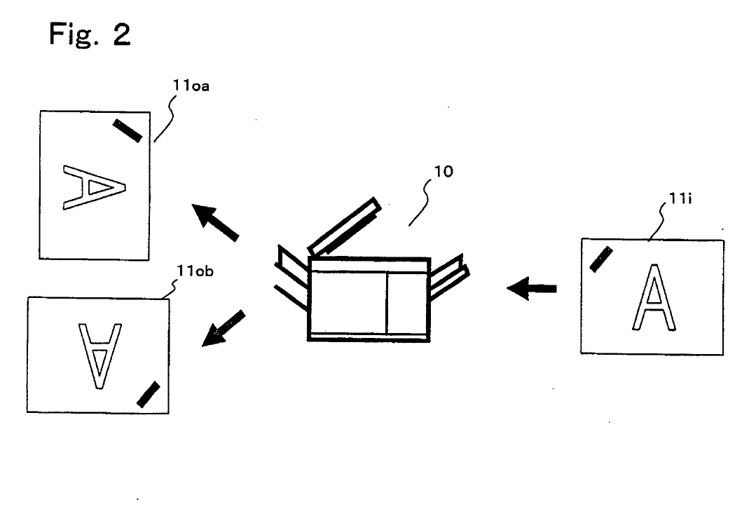

FIG. 1 and FIG. 2 show a case where the user wishes stapling processing to be performed at the upper left corner of a pile of printed recording sheets. FIG. 1 will be described first. The user manipulates the image forming apparatus so that stapling processing is performed at the upper left corner of a pile of printed, portrait recording sheets as is indicated by 11i on the right of the drawing. In this instance, when recording sheets of the portrait configuration are set in the paper feeding portion of the image forming apparatus, as is indicated by 11oa on the upper left of the drawing, stapling is performed as the user desires. Herein, for the post-processing, such as stapling, to be enabled, it is necessary to specify stapling processing or the like in the vicinity of a side of the recording sheet, which is the side discharged last from the paper discharge outlet of the image forming apparatus among the sides of a printed recording sheet. The case of 11oa in the drawing meets this condition.

Meanwhile, even when recording sheets of the landscape configuration are set in the paper feeding portion of the image forming apparatus, as is indicated by 11ob on the lower left of the drawing, stapling processing is also performed as the user desires. In this case, the image forming apparatus acknowledges the need to rotate the input image data by 90° (90 degrees) on the basis of print job information and information that recording sheets of the portrait configuration are not set in the paper feeding portion and recording sheets of the landscape configuration are set instead. In addition, the image forming apparatus judges that it is possible to perform stapling at the position specified by the user by rotating the input image data by 90° (90 degrees). In this manner, even when recording sheets of the landscape configuration are set in the paper feeding portion of the image forming apparatus, it becomes possible to perform stapling at the upper left corner of a pile of recording sheets of the landscape configuration as is indicated by 11ob on the lower left of the drawing by rotating the input image data by 90° (90 degrees).

FIG. 2 will now be described. In this case, the user manipulates the image forming apparatus so that stapling processing is performed at the upper left corner of a pile of printed landscape recording sheets as is indicated by 11i on the right of the drawing. In this instance, when recording sheets of the landscape configuration are set in the paper feeding portion of the image forming apparatus, stapling processing is performed as the user desires as is indicated by 11ob on the lower left of the drawing. When recording sheets of the portrait configuration are set in the paper feeding portion of the image forming apparatus, it becomes possible to perform stapling at the upper left corner of a pile of recoding sheets of the portrait configuration as is indicated by 11oa on the upper left of the drawing by rotating the input image data by 90° (90 degrees) in the same manner as the case of 11ob in FIG. 1.

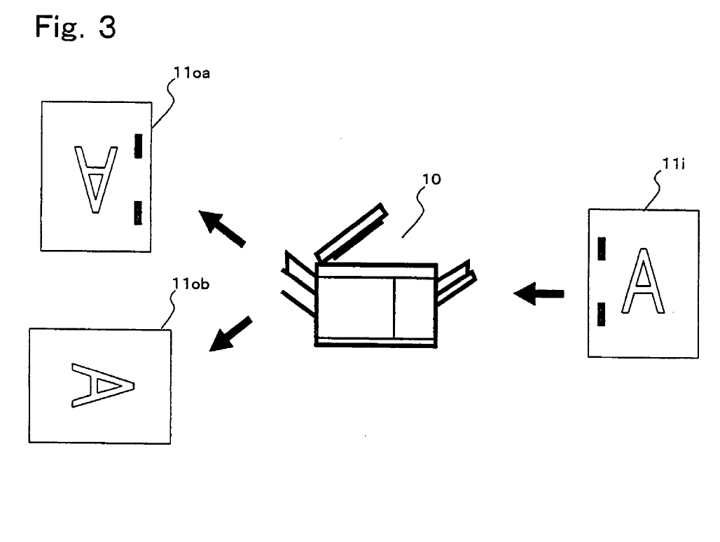

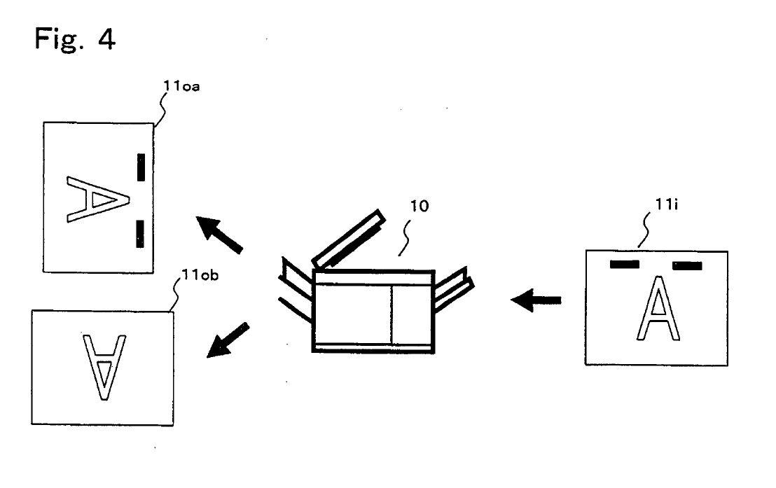

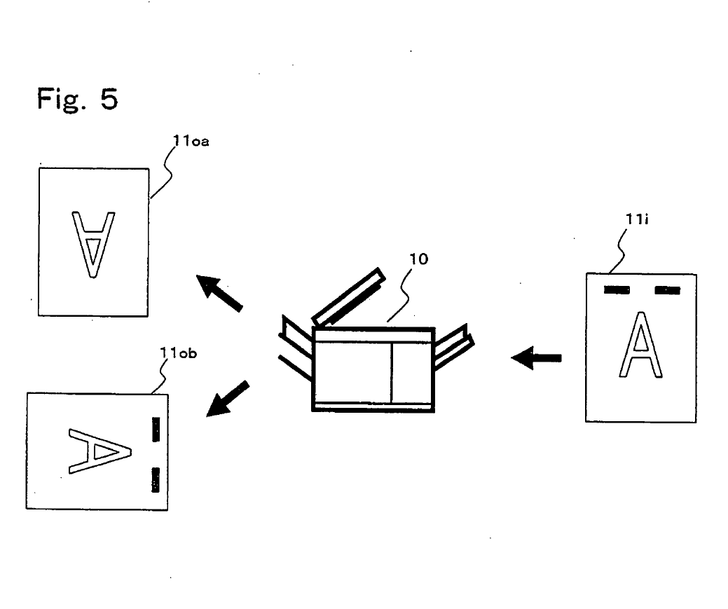

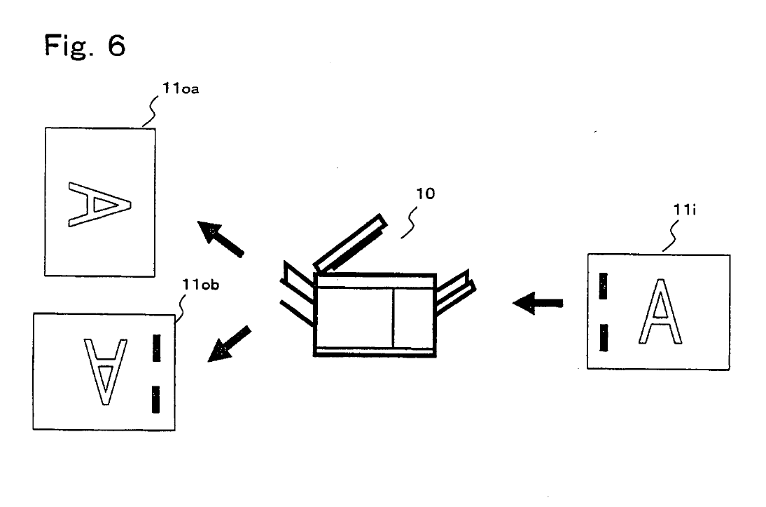

However, in the cases A and B described above, even when the input image data is rotated, as are shown in FIG. 3, FIG. 4, FIG. 5, and FIG. 6, it is impossible to perform stapling processing at the position the user desires.

More specifically, as is the case A, when the user wishes rectangular recording sheets 11o to be stapled in the long side portion, as are shown in FIG. 3 and FIG. 4, recording sheets 11oa set in the portrait orientation are stapled in the long side portion; however, recording sheets 11ob set in the landscape orientation are not stapled in the long side portion. Consequently, stapling is not performed when the recording sheets 11oa of the portrait configuration are not set in the paper feeding portion of the image forming apparatus 10.

Likewise, as in the case B, when the user wishes rectangular recording sheets 11o to be stapled in the short side portion, as are shown in FIG. 5 and FIG. 6, recording sheets 11ob set in the landscape orientation are stapled in the short side portion; however, recording sheets 11oa set in the portrait orientation are not stapled in the short side portion. Consequently, stapling is not performed when the recording sheets 11ob of the landscape configuration are not set in the paper feeding portion of the image forming apparatus 10.

While the case where stapling processing is performed and the case where stapling processing is not performed have been described with reference to FIG. 1 through FIG. 6, the same description applies to punching processing.

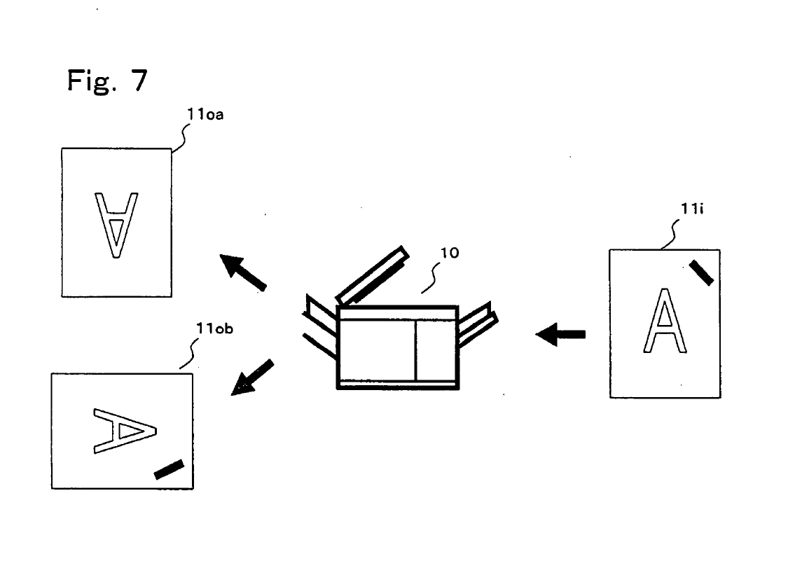

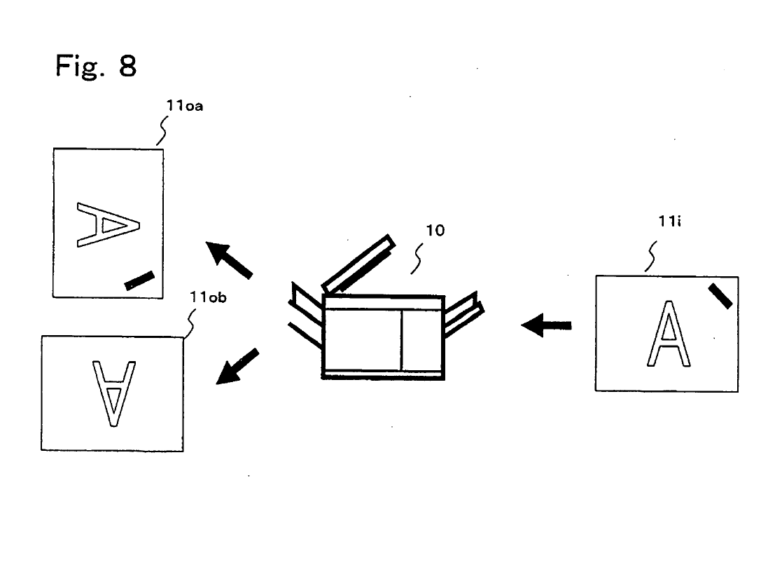

In the cases C and D, as are shown in FIG. 7 and FIG. 8, there may be a cases where stapling processing is not performed at the position the user desires.

The case C will be described as follows. That is, when the user wishes portrait recording sheets 11i to be stapled at the upper right corner as is shown on the right of FIG. 7, as is shown on the left of the drawing, stapling is performed at the upper right corner on recording sheets 11ob set in the landscape orientation; however, stapling is not performed at the upper right corner on recording sheets 11oa set in the portrait orientation. Consequently, stapling is not performed when the recording sheets 11ob of the landscape configuration are not set in the paper feeding portion of the image forming apparatus 10.

Likewise, the case D will be described as follows. That is, when the user wishes landscape recording sheets 11i to be stapled at the upper right corner as is shown on the right of FIG. 8, as is shown on the left of the drawing, stapling is performed at the upper right corner on recording sheets 11oa set in the portrait orientation; however, stapling is not performed at the upper right corner on recording sheets 11ob set in the landscape orientation. Consequently, stapling is not performed when the recording sheets 11oa of the portrait configuration are not set in the paper feeding portion of the image forming apparatus 10.

There is an image forming apparatus that performs stapling even in the case C or the case D by rotating input image data by 180 degrees. However, because such a need seldom occurs, in general, many types of the image forming apparatus are not supported for the processing to rotate input image data by 180 degrees. Hence, when the current state applies to the case C or the case D, many types of the image forming apparatus do not perform stapling processing as described above.

This embodiment is therefore configured in such a manner that when printing is executed with a stapling command or a punching command, it is possible to prevent an event that printed recording sheets are outputted without being stapled or punched for the reason that sheets being set are inappropriate in preventing wastage of printing sheets, toner, etc. produced by outputting printed matter the user does not wish to obtain, so that the time and labor to re-transmit the job can be saved.

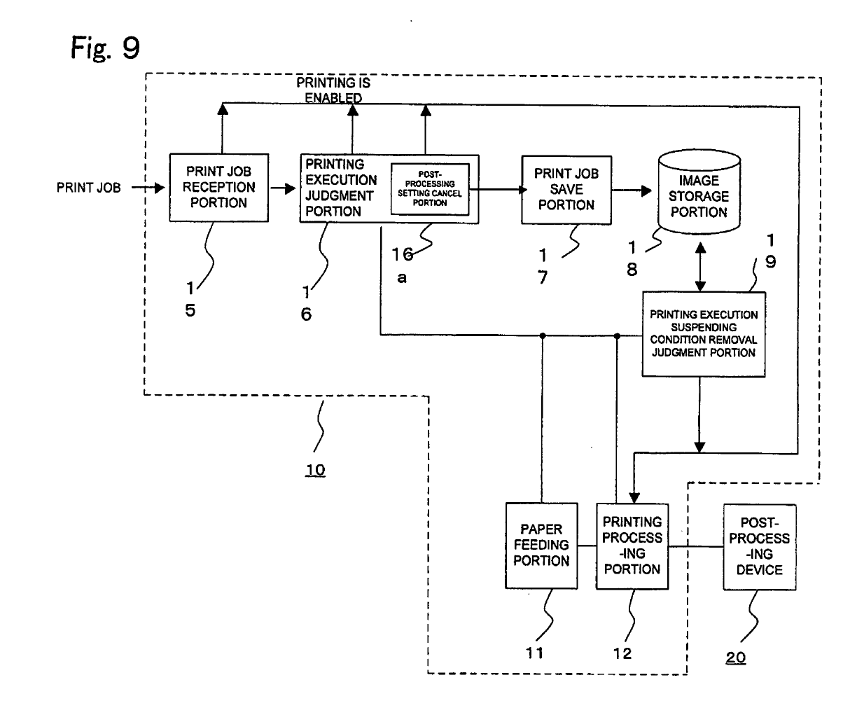

FIG. 9 is a functional block diagram schematically showing the configuration of an image forming system adopting an image forming apparatus that prints out image information inputted in a specific manner on recording sheets by a print job, such as a copier, a printer, or MFP (Multi-Function Peripherals) furnished with functions of these machines, that is, the first embodiment of the image forming apparatus of the invention.

An image forming apparatus 10 includes a paper feeding portion 11 and a printing processing portion 12. The paper feeding portion 12 accommodates, for example, A4-size or letter-size recording sheets that are set in the portrait or landscape orientation, and feeds the recording sheets one by one while printing is executed. The paper feeding portion 11 includes a cassette to accommodate recording sheets or a manual tray. The printing processing portion 12 performs certain printing processing on recording sheets fed from the paper feeding portion 11 according to a print job described below. A post-processing device 20 is capable of performing stapling or punching processing in a specified portion, that is, in any of a corner portion, a long side portion, and a short side portion of a pile of printed recording sheets when post-processing, such as stapling and punching, is set in the print job.

A print job reception portion 15 receives a print job from an unillustrated processing portion in the preceding stage. The print job reception portion 15 performs processing on image data contained in the data of the received print job. Further, the print job reception portion 15 judges whether post-processing, such as stapling or punching, for printed recording sheets is set in the received print job. When the judgment result reveals that the stapling or punching is not set in the received print job, the print job reception portion 15 sends the data of the received print job to the printing processing portion 12 to enable printing by the printing processing portion 12. On the other hand, upon judging that the stapling or punching is set in the received print job, the print job reception portion 15 sends the data of the received print job to a printing execution judgment portion 16.

When the print job reception means 15 judges the setting of stapling or punching, the printing execution judgment portion 16 judges whether recording sheets for printing are set in the paper feeding portion 11 in a state for stapling or punching to be performed. In other words, stapling or punching processing is set in the print job to specify the stapling or punching position, that is, a corner portion, a long side portion, and a short side portion of recording sheets. The printing execution judgment portion 16 therefore judges whether stapling or punching processing is to be performed at the position thus set from the state of the recording sheets set in the paper feeding portion 11. The judgment conditions will be described below. When the judgment result reveals that the recording sheets are set in a direction in which stapling or punching is enabled for the print job, the printing execution judgment portion 16 sends the data of the print job to the printing processing portion 12 to enable printing by the printing processing portion 12.

Judgment conditions under which stapling or punching processing is not performed at the specific position of the recording sheets set in the print job correspond to the four conditions A, B, C, and D described above. These are re-written as follows for the system of FIG. 9.

A: a case where the print job is set to perform stapling or punching in the long side portion of a pile of recording sheets, but the recording sheets are not set in the paper feeding portion 11 in an orientation (the portrait orientation) for the long side portion to be perpendicular to the direction of transportation of the recording sheets.

B: a case where the print job is set to perform stapling or punching in the short side portion of a pile of the recording sheets, but the recording sheets are not set in the paper feeding portion 11 in an orientation (the landscape orientation) for the short side portion to be perpendicular to the direction of transportation of the recording sheets.

C: a case where the print job is set to perform stapling in the upper left corner portion of a pile of portrait recording sheets, but the recording sheets are not set in the paper feeding portion 11 in an orientation (the landscape orientation) for the short side portion to be perpendicular to the direction of transportation of the recording sheets.

D: a case where the print job is set to perform stapling in the upper right corner portion of a pile of landscape recording sheets, but the recording sheets are not set in the paper feeding portion 11 in an orientation (the portrait orientation) for the long side portion to be perpendicular to the direction of transportation of the recording sheets.

Also, the printing execution judgment portion 16 includes a post-processing setting cancel portion 16a that cancels the setting of stapling or punching in the print job upon judgment that the recording sheets are not set in a direction in which stapling or punching is enabled, thereby enabling printing on the recording sheets by the print job. The user sets in advance whether to enable or disable the function of canceling the setting of stapling or punching in the print job furnished to the post-processing setting cancel portion 16a.

In a case where the printing execution judgment portion 16 judges that the recording sheets are not set in a direction in which stapling or punching is enabled at the position set in the print job and the function of the post-processing setting cancel portion 16a is disabled, a print job save portion 17 saves print job data in an image storage portion 18 by appending a save serial number. In short, in this case, the print job is in a state where the execution of printing is suspended.

Numeral 19 denotes a printing execution suspending condition removal judgment portion that judges whether the condition (any one of the conditions A, B, C, and D described above), under which execution of printing for the print job saved in the image storage portion 18 is suspended, has been removed. For the print job for which the printing execution suspending condition has been removed, printing on recording sheets by the printing processing portion 12 is executed. In this instance, the save serial numbers appended to print jobs saved in the image storage portion 18 are moved up. The print jobs for which the printing execution suspending condition has not been removed are kept saved. In any case, the next print job saved in the image storage portion 18 is subjected to judgment.

The printing execution suspending condition removal judgment portion 19 includes a precedence mode selection portion that allows the user to select a saved job precedence mode in which a priority is given to the printing execution suspending condition removal judgment for a saved job saved in the image storage portion 18, or a received job precedence mode in which a priority is given to the processing of a newly received print job. The user selects either of the precedence modes in advance. When the saved job precedence mode is selected through the precedence mode selection portion, the print jobs saved in the image storage portion 18 are successively subjected to judgment as to whether the printing execution suspending condition has been removed. On the other hand, when the received job precedence mode is selected, a priority is given to certain processing for the print job newly received at the print job reception means 15 for the certain processing to be performed.

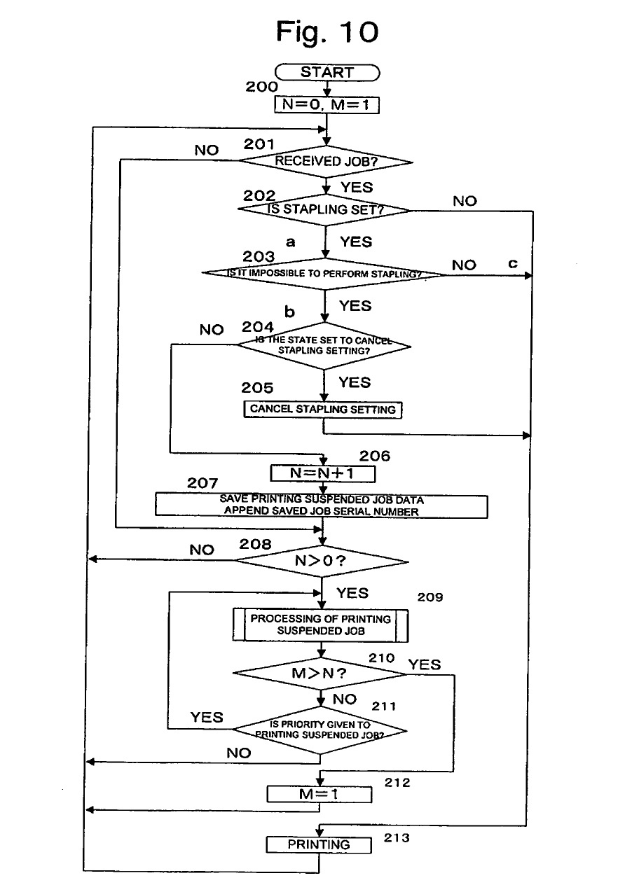

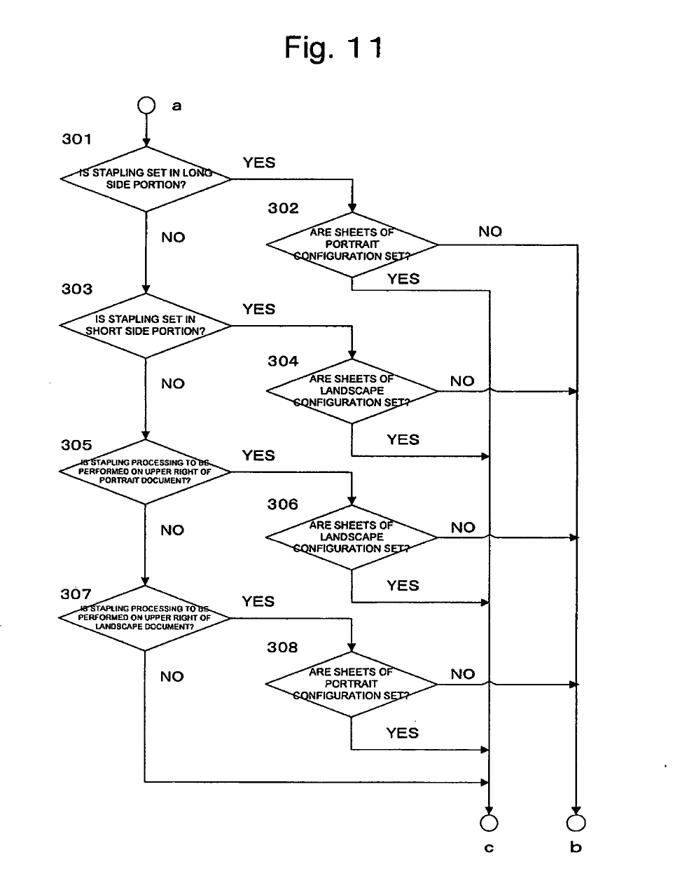

An overall operation will now be described with reference to the flow chart of FIG. 10. A print job in which punching processing is set is also executed; however, for ease of description, only the processing of a print job in which stapling processing is set will be described.

Firstly, in the initial settings, 0 is set to N indicating the largest value among the serial numbers appended to saved jobs saved in the image storage portion 18, that is, the number of saved jobs, and 1 is set to a parameter M used in the printing execution suspending condition removal judgment processing described below (Step 200).

Subsequently, whether the print job reception means 15 has received a print job is judged in Step 201, and when no print job has been received, the flow proceeds to the printing execution suspending condition removal judgment processing in Step 209 and the following steps described below. When a print job has been received, whether stapling processing is specified in this print job as the setting of the print job is judged (Step 202).

When it is judged in Step 202 that stapling processing is not specified, printing on recording sheets is executed by the printing processing portion 12 (Step 213), and the flow returns to Step 201. On the contrary, when it is judged in Step 202 that stapling processing is specified, whether it is impossible to perform stapling processing is judged by the printing execution judgment portion 16 on the basis of the stapling position set in the print job and the information about the direction of recording sheets set in the paper feeding portion 11 of the image forming apparatus (Step 203). When the judgment result reveals that it is possible to perform the stapling processing (NO in Step 203), the flow proceeds to printing processing (Step 213) from c. When it is impossible to perform stapling processing (YES in Step 203), as will be described below, the flow proceeds to judgment processing (Step 204) regarding the post-processing cancel portion 16a from b.

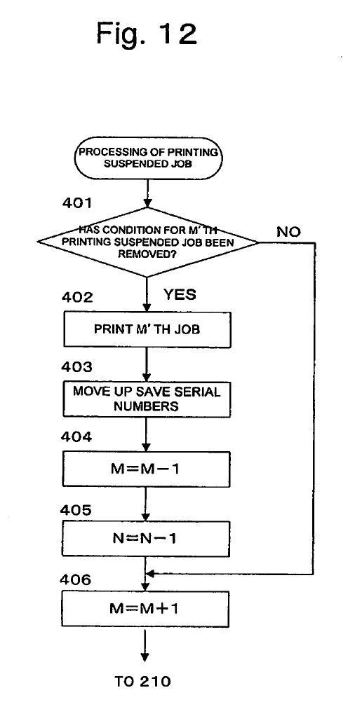

Whether it is impossible to perform stapling processing is judged in Step 203 on the basis of the judgment conditions A, B, C, and D described above, and an example of the judgment process will be described with reference to FIG. 11.

According to an example of an operation to judge whether it is impossible to perform stapling processing as detailed in FIG. 11, the position of the stapling setting is judged first, and then the orientation of sheets set in the paper feeding portion is judged. On the basis of these judgments, whether the current state applies to any of the judgment conditions A, B, C, and D is judged.

In Step 202 of FIG. 10, when it is judged that stapling processing is set in the print job, (a), the flow proceeds to an operation to judge whether it is impossible to perform stapling processing as detailed in FIG. 11. Initially, whether the stapling position set in the print job is the long side portion of the recording sheets is judged first (Step 301). When the stapling position set in the print job is the long side portion, whether sheets of the portrait configuration are set in the paper feeding portion 11 is judged (Step 302). In this instance, when sheets of the portrait configuration are not set in the paper feeding portion 11, the current state applies to the judgment condition A. It is therefore impossible to perform stapling processing, and the flow proceeds to Step 204 of FIG. 10. When sheets of the portrait configuration are set in the paper feeding portion 11, the flow proceeds to Step 213 of FIG. 10 because it is possible to perform stapling processing, and printing finished with stapling is executed. When the stapling position set in the print job is not the long side portion, the flow proceeds to Step 303.

In Step 303, whether the stapling position set in the print job is the short side portion of the recording sheets is judged. When the stapling position set in the print job is the short side portion, whether recording sheets of the landscape configuration are set in the paper feedingportion 11 is judged (Step 304). In this instance, when recording sheets of the landscape configuration are not set in the paper feeding portion 11, the current state applies to the judgment condition B. It is therefore impossible to perform stapling processing, and the flow proceeds to Step 204 of FIG. 10. When recording sheets of the landscape configuration are set in the paper feeding portion 11, the flow proceeds to Step 213 of FIG. 10 because it is possible to perform stapling processing, and printing finished with stapling is executed. When the stapling position set in the print job is not the short side portion, the flow proceeds to Step 305.

Thereafter, whether the stapling position set in the print job is on the upper right of the recording sheets for a portrait document is judged in Step 305, and whether the stapling position is on the upper right for a landscape document is judged in Step 307 in the same manner as above. Following the respective judgments, whether recording sheets set in the paper feeding portion 11 are of the landscape or portrait configuration is judged. When the judgment result applies to the judgment condition C or D, the flow proceeds to Step 204 of FIG. 10 because it is impossible to perform stapling processing. When the judgment result applies to neither the judgment condition C nor D, the flow proceeds to Step 213 of FIG. 10 because it is possible to perform stapling processing, and printing finished with stapling is executed.

While the operation to judge whether it is impossible to perform stapling processing has been described with reference to FIG. 11, the order of judgments on the stapling setting position in Step 301, Step 303, Step 305, and Step 07 is not limited to the order of the example shown in FIG. 11. The order is arbitrary and can be different from the one shown in FIG. 11. It should be noted, however, that when the order is different from the one shown in FIG. 11, the judgment of the state of the recording sheets being set in Step 302 or the like, which is performed only when a positive result is obtained from the judgment on the stapling setting position in Step 301 or the like, follows the judgment on the corresponding stapling setting position.

In addition, FIG. 11 shows an example where whether it is impossible to perform stapling processing is judged by judging the stapling setting position first, and then by judging the state of recording sheets being set. However, it goes without saying that the state of the recording sheets being set can be judged first, followed by the judgment as to whether it is impossible to perform stapling processing.

When it is judged that it is impossible to perform stapling from the judgment processing in Step 203 where whether it is impossible to perform stapling processing is judged as described above, as has been described, the flow proceeds from b to judgment processing (Step 204) where whether the setting of stapling processing is cancelled by the post-processing setting cancel portion 16a is judged. When the post-processing setting cancel portion 16a is in a state to cancel the stapling setting, the stapling setting in the print job is cancelled (Step 205), and the flow proceeds to printing processing (Step 213).

On the contrary, when the post-processing setting cancel portion 16a is not in a state to cancel the stapling setting (NO in Step 204), execution of printing is suspended. In this instance, the print job save portion 17 increments the parameter N (Step 206), and saves the corresponding print job data in the image storage portion 18, after which it appends N, which is incremented in Step 206, to this print job as the saved job serial number (the number of saved jobs) (Step 207).

Subsequently, the printing execution suspending condition removal judgment portion 19 checks the number of print jobs saved in the image storage portion 18 (Step 208), and the flow returns to Step 201 unless the number of saved jobs satisfies, N>0.

On the contrary, when the number of saved jobs satisfies, N>0, processing is performed to judge whether the condition under which execution of printing is suspended has been removed for a saved job for which execution of printing is suspended (Step 209). FIG. 12 details the processing of a printing suspended job in Step 209. Initially, whether the printing execution suspending condition (any of A, B, C, and D described above) has been removed for an M'th job being saved is checked in Step 401. When the printing execution suspending condition has not been removed (NO in Step 401), the parameter M is incremented (Step 406) to check a printing suspended job with the next save serial number, and the flow proceeds to Step 210.

On the contrary, when the printing execution suspending condition has been removed for the M'th job (YES in Step 401), the job is printed (Step 402), and the saved job serial numbers are moved up (Step 403). Further, after the parameters M and N are decremented independently (Steps 404 and 405, respectively), the parameter M is incremented (Step 406) to specify a printing suspended job with the next save serial number, and the flow proceeds to Step 210.

Referring to FIG. 10 again, whether M>N is satisfied is judged in Step 210. To satisfy M>N means that judgment on removal of the printing execution suspending condition is completed for all the printing suspended jobs saved in the image storage portion 18. When the judgment result reveals that M>N is satisfied (YES in Step 210), because judgment on removal of the printing execution suspending condition is completed for all the printing suspended jobs saved in the image storage portion 18, the parameter M is set to 1 (Step 212) and the flow returns to the processing regarding the print job reception means 15 (Step 201). On the contrary, when M>N is not satisfied (NO in Step 210), it means that a printing suspended job is saved in the image storage portion 18, for which judgment as to whether the printing execution suspending condition has been removed is not completed. Hence, whether the processing for a printing suspended job is repeated continuously or the processing is performed for a print job newly received at the print job reception means is judged (Step 211).

In other words, as has been described, the printing execution suspending condition removal judgment portion 19 includes the precedence mode selection portion that allows the user to select either the saved job precedence mode in which a priority is given to the printing execution suspending condition removal judgment for a saved job saved in the image storage portion 18 or the received job precedence mode in which a priority is given to the processing of a newly received print job. The user, by using this selection portion, makes a selection in advance regarding to which of the processing of a saved job and the processing of a received job a priority is given. For example, in a case where a selection is made to give a priority to the printing suspended job being saved (YES in Step 211), Step 209 through Step 211 are repeated to check whether the printing execution suspending condition has been removed for all the printing suspended jobs. When the judgment on all the printing suspended jobs saved in the image storage portion 18 ends by this sequence of processing (YES in Step 210), M=1 is set (Step 212), and the flow returns to the processing (201) regarding the print job reception means 15.

On the contrary, when the user has made in advance a selection to give a priority to a received job (NO in Step 211), the flow returns to Step 201 each time one printing suspended job is checked to perform processing for a newly received print job.

Saving of a print job in the image storage portion 18 and the operation to check whether the printing execution suspending condition has been removed for the saved job(s) will be described further using concrete examples.

(1) A case where a first received job A is saved and the condition is removed later

Initially, a first job A is saved according to the judgment in Step 204 (Steps 206 and 207).

State: N=1, M=1, and first saved job=job A

Because the job is saved in the image storage portion 18 in the preceding step, N has been set to 1 in Step 208. The flow therefore proceeds to Step 401 within Step 209. In Step 401, whether the condition for the first (M=1) saved job A has been removed is judged. When the judgment result reveals that the condition has been removed, the flow proceeds to Step 402 to print the job A.

Subsequently, the flow proceeds to Step 403 where the saved job serial numbers are moved up. Step 403 is the processing of moving up the saved job serial numbers sequentially. For example, when the first saved job is printed among plural saved jobs, the second saved job is moved up to the first place and the third saved job is moved up to the second place. In the case herein, however, because only one job is saved from the start, the saved serial numbers cannot be moved up. No processing is therefore performed.

Because one job is reduced from the saved jobs by the printing, M is decremented in Step 404.

State: N=1, M=0, and no job is saved

Also, because one job is reduced from the saved jobs, N is decremented in Step 405.

State: N=0, M=0, and no job is saved

In Step 406, M is incremented for preparation to check the next saved job.

State: N=0, M=1, and no job is saved

When the judgment in Step 210 reveals that M is larger than N, it means that judgment on removal of the condition is completed for all the printing suspended jobs. Hence, when M>N is satisfied, the flow proceeds to Step 212 to restore M to 1, so that the image forming apparatus is ready to check whether the condition has been removed for the saved print jobs again from the first saved job. Because M>N is satisfied under the preconditions described above, the flow proceeds to Step 212.

On the contrary, when M>N is not satisfied, it means that a saved job that has not been checked is present. The flow therefore proceeds to Step 211. In Step 211, when a selection is made to give a priority to the processing of a printing suspended job, the flow returns to Step 209; otherwise, the presence of a received job is checked.

(2) A case where the condition for a second saved job is removed after three received jobs are saved when it is set to give a priority to saved jobs

A first received job is saved in Steps 206 and 207.

State: N=1, M=1, and first saved job=job A

Because the job is saved in the image storage portion 18 in the preceding step, N has been set to 1 in Step 208. The flow therefore proceeds to Step 401 within Step 209. In Step 401, whether the condition for M=1, that is, the first saved job A has been removed is judged.

Herein, the flow proceeds to Step 406 on the assumption that the condition for the job A has not been removed. In Step 406, M is incremented for preparation to check the next saved job.

State: N=1, M=2, and first saved job=job A

The flow then proceeds to Step 210, and because M>N is satisfied, the flow proceeds to Step 212. Because M=1 in Step 212, the flow returns to Step 201 at the top.

State: N=1, M=1, and first saved job=job A

In Step 201, a next print job B is received. When this print job is judged as the one that needs to be saved in Step 204, the received job B is also saved in the image storage portion 18.

State: N=2, M=1, and first saved job=job A
second saved job=job B

Because another job is saved in the storage device in the preceding step, N has been set to 2 in Step 208. The flow therefore proceeds to Step 401 within Step 209. In Step 401, whether the condition for M=1, that is, the first saved job A has been removed is judged again. Herein, the flow proceeds to Step 406 on the assumption that the condition for the job A has not been removed.

In Step 406, M is incremented for preparation to check the next saved job.

State: N=2, M=2, and first saved job=job A
second saved job=job B

The flow then proceeds to Step 210, and because M>N is not satisfied (there is a saved job that has not been checked), the flow proceeds to Step 211. Because it is set to give a priority to the saved jobs in Step 211, the flow returns to Step 401 within Step 209.

In Step 401, the flow proceeds to Step 406 on the assumption that the condition for the job B has not been removed. In Step 406, M is incremented for preparation to check the next saved job.

State: N=2, M=3, and first saved job=job A
second saved job=job B

The flow proceeds to Step 210 once again, and because M>N is satisfied (all the saved jobs have been checked), the flow proceeds to Step 212. Because M=1 in Step 212, the flow returns to Step 201 at the top.

State: N=2, M=1, and first saved job=job A
second saved job=job B

In Step 201 at the top, a next print job C is received again. When this print job C is judged as the one that needs to be saved in Step 204, the received job C is also saved in the image storage portion 18.

State: N=3, M=1, and first saved job=job A
second saved job=job B
third saved job=job C

Because still another job is saved in the storage device in the preceding step, N has been set to 3 in Step 208. The flow therefore proceeds to Step 401 within Step 209. In Step 401, whether the condition for M=1, that is, the first saved job A has been removed is judged once again. Herein, the flow proceeds to Step 406 on the assumption that the condition for the job A has not been removed. In Step 406, M is incremented for preparation to check the next saved job.

State: N=3, M=2, and first saved job=job A
second saved job=job B
third saved job=job C

The flow then proceeds to Step 210, and because M>N is not satisfied (there is a saved job that has not been checked), the flow proceeds to Step 211. Because it is set to give a priority to the saved jobs in Step 211, the flow returns to Step 401 within Step 209, and whether the condition for M=2, that is, the second saved job B has been removed is judged. Herein, the flow proceeds to Step 402 to print the job B on the assumption that the condition for M=2, that is, the second saved job B has been removed.

The flow then proceeds to Step 403 where the saved job serial numbers are moved up. In Step 403, as has been described, when the second saved job B is printed among the plural, herein, three saved jobs, the job C in the third place is moved up to the second place.

State: N=3, M=2, and first saved job=job A
second saved job=job C

Also, because one job is reduced from the saved jobs because of the printing, M is decremented in Step 404.

State: N=3, M=1, and first saved job=job A
second saved job=job C

Further, because one job is reduced from the saved jobs, N is decremented in Step 405.

State: N=2, M=1, and first saved job=job A
second saved job=job C

In Step 406, M is incremented for preparation to check the next saved job.

State: N=2, M=2, and first saved job=job A
second saved job=job C

Subsequently, the flow proceeds to Step 210, and because M>N is not satisfied, the flow proceeds to Step 211. Because it is set to give a priority to the saved jobs in Step 211, the flow returns to Step 401 within Step 209. In Step 401, whether the condition for M=2, that is, the second saved job C has been removed is judged. Herein, the flow proceeds to Step 406 on the assumption that the condition for the saved job C has not been removed. In Step 406, M is incremented for preparation to check the next saved job.

State: N=2, M=3, and first saved job=job A
second saved job=job C

The flow returns to Step 210 again, and because M>N is satisfied, the flow proceeds to Step 212, where M is restored to 1. The flow then returns to Step 201 at the top.

State: N=2, M=1, and first saved job=job A
second saved job=job C

In this manner, for the printing suspended jobs saved in the image storage portion 18, whether the printing execution suspending condition has been removed is checked one by one. Printing is executed for those for which the condition has been removed, and those for which the condition has not been removed are kept saved.

While the case where the stapling processing is performed has been chiefly described, it is obvious that the embodiment of the invention is basically applicable to a case where the punching processing is performed.

Consequently, when printing is executed for a print job with a stapling command or a punching command, it is possible to prevent printed recording sheets from being outputted without being stapled or punched for the reason that recording sheets set in the paper feeding portion of the image forming apparatus are inappropriate. It is therefore possible to prevent wastage of recording sheets, toner, etc. produced by outputting printed matter that the user does not wish to obtain. Moreover, the time and labor to re-transmit the job can be saved.

Although exemplary embodiments of the present invention have been shown and described, it will be apparent to those having ordinary skill in the art that a number of changes, modifications, or alternations to the invention as described herein may be made, none of which depart from the sprit of the present invention. All such changes, modifications, and alternations should therefore be seen as within the scope of the present invention.

What is claimed is:

1. An image forming apparatus that is available with a post-processing device capable of performing one of stapling and punching in any of a corner portion, a long side portion, and a short side portion of a pile of printed, rectangular recording sheets, comprising:
a print job reception portion that receives a print job on the recording sheets and judges whether one of stapling and punching on the recording sheets is set in the print job to enable printing by the print job when neither of the stapling and the punching is set;
a printing execution judgment portion that judges whether the recording sheets are set in a direction in which one of the stapling and the punching is enabled at one of a set stapling position and a set punching position when one of the stapling and the punching in any of the corner portion, the long side portion, and the short side portion of a pile of the recording sheets is set in the received job, and enables printing by the print job when the recording sheets are set in the direction in which one of the stapling and the punching is enabled;
a print job save portion that saves the print job in an image storage portion under a printing suspending condition together with a save serial number when the recording sheets are not set in the direction in which one of the stapling and the punching set in the print job is enabled; and
a printing execution suspending condition removal judgment portion that judges whether the printing execution suspending condition has been removed for print jobs saved in the image storage portion, enables printing on the recording sheets to be executed for a print job for which the printing execution suspending condition has been removed, and moves up save serial numbers appended to the print jobs saved in the image storage portion while print jobs for which the printing execution suspending condition has not been removed are kept saved, so that a next print job saved in the image storage portion is subjected to judgment.

2. The image forming apparatus that is available with a post-processing device capable of performing one of stapling and punching in any of a corner portion, a long side portion, and a short side portion of a pile of printed, rectangular recording sheets according to claim 1, wherein:
the printing execution judgment portion judges that the recording sheets are not set in the direction in which one of the stapling and the punching is enabled under a condition that the recording sheets are not set in an orientation for the long side portion to be perpendicular to a direction of transportation of the recording sheets when the print job is set to perform one of the stapling and the punching in the long side portion of a pile of the recording sheets.

3. The image forming apparatus that is available with a post-processing device capable of performing one of stapling and punching in any of a corner portion, a long side portion, and a short side portion of a pile of printed, rectangular recording sheets according to claim 1, wherein:
the printing execution judgment portion judges that the recording sheets are not set in the direction in which one of the stapling and the punching is enabled under a condition that the recording sheets are not set in an orientation for the short side portion to be perpendicular to a direction of transportation of the recording sheets when the print job is set to perform one of the stapling and the punching in the short side portion of a pile of the recording sheets.

4. The image forming apparatus that is available with a post-processing device capable of performing one of stapling and punching in any of a corner portion, a long side portion, and a short side portion of a pile of printed, rectangular recording sheets according to claim 1, wherein:
the printing execution judgment portion judges that the recording sheets are not set in the direction in which one of the stapling and the punching is enabled under a condition that the recording sheets are not set in an orientation for the short side portion to be perpendicular to a direction of transportation of the recording sheets when the print job is set to perform stapling in an upper right corner portion of a pile of portrait recording sheets.

5. The image forming apparatus that is available with a post-processing device capable of performing one of stapling and punching in any of a corner portion, a long side portion, and a short side portion of a pile of printed, rectangular recording sheets according to claim 1, wherein:
the printing execution judgment portion judges that the recording sheets are not set in the direction in which one of the stapling and the punching is enabled under a condition that the recording sheets are not set in an orientation for the long side portion to be perpendicular to a direction of transportation of the recording sheets when the print job is set to perform stapling in an upper right corner portion of a pile of landscape recording sheets.

6. The image forming apparatus that is available with a post-processing device capable of performing one of stapling and punching in any of a corner portion, a long side portion, and a short side portion of a pile of printed, rectangular recording sheets according to claim 1, wherein:
the printing execution suspending condition removal judgment portion makes it possible to select whether a priority is given to saved jobs, so that in a case where a selection is made to give a priority to the saved jobs, when a next print job saved in the image storage portion is subjected to judgment, a priority is given to the print job that is now being judged and whether the printing execution suspending condition for the print job to be saved in the image storage portion has been removed is judged, and in a case where a selection is made not to give a priority to the saved jobs, a priority is given to certain processing for a print job newly received at the print job reception portion for the certain processing to be performed.

7. The image forming apparatus that is available with a post-processing device capable of performing one of stapling and punching in any of a corner portion, a long side portion, and a short side portion of a pile of printed, rectangular recording sheets according to claim 1, wherein:
the printing execution suspending condition removal judgment portion judges whether the printing execution suspending condition has been removed for print jobs from a print job saved first when more than one print job is saved in the image storage portion.

8. The image forming apparatus that is available with a post-processing device capable of performing one of stapling and punching in any of a corner portion, a long side portion, and a short side portion of a pile of printed, rectangular recording sheets according to claim 1, wherein:
the printing execution suspending condition removal judgment portion next judges whether the printing execution suspending condition has been removed for print jobs from a print job saved first after judgment on removal of the printing execution suspending condition is completed for all the print jobs being saved when more than one print job is saved in the image storage portion.

9. The image forming apparatus that is available with a post-processing device capable of performing one of stapling and punching in any of a corner portion, a long side portion, and a short side portion of a pile of printed, rectangular recording sheets according to claim 1, wherein:
the printing execution judgment portion includes a post-processing setting cancel portion that cancels one of the stapling and the punching set in the print job when it is judged that the recording sheets are not set in the direction in which one of the stapling and the punching is enabled, so that printing on the recording sheets by the print job is enabled.
